(19) United States
(12) Patent Application Publication
(10) Pub. No.: US 2019/0377224 A1
(43) Pub. Date: Dec. 12, 2019

(54) LIQUID CRYSTAL DISPLAY DEVICE

(71) Applicant: SHARP KABUSHIKI KAISHA, Osaka (JP)

(72) Inventor: SHIGENORI TANAKA, Osaka (JP)

(21) Appl. No.: 16/424,881

(22) Filed: May 29, 2019

Related U.S. Application Data
(60) Provisional application No. 62/682,702, filed on Jun. 8, 2018.

(51) Int. Cl. G02F 1/1335; G02F 1/13357

(52) U.S. Cl. CPC G02F 1/133528; G02F 2202/28; G02F 1/1336; G02F 1/133512

(57) ABSTRACT

A liquid crystal display device includes a liquid crystal panel including two transparent substrates and a liquid crystal layer enclosing liquid crystals between the two transparent substrates, the liquid crystal panel having an alignment control region in which alignment of the liquid crystals is controlled, a polarizing plate disposed opposite a back surface of the liquid crystal panel, a backlight disposed opposite a surface of the polarizing plate, and an optical film including a front surface section disposed on a front surface of the liquid crystal panel and an extended section extending from one edge of the front surface section and attached to a part of a side surface or a part of a back surface of the backlight. The front surface section includes a polarizing section that polarizes transmission light and overlaps the alignment control region.

### CROSS REFERENCE TO RELATED APPLICATION

This application claims priority from U.S. Provisional Application No. 62/682,702 filed on Jun. 8, 2018. The entire contents of the priority application are incorporated herein by reference.

### TECHNICAL FIELD

The present technology described herein relates to a liquid crystal display device including a liquid crystal panel and a backlight.

### BACKGROUND ART

A liquid crystal display device generally includes a liquid crystal panel, a front surface side polarizing plate, a rear surface side polarizing plate, and a backlight. The liquid crystal panel includes two transparent substrates and a liquid crystal layer enclosing liquid crystals between the two transparent substrates to have an alignment control area where alignment of the liquid crystals can be controlled. The front surface side polarizing plate is disposed opposite a front surface of the liquid crystal panel. The rear surface side polarizing plate is disposed opposite a rear surface of the liquid crystal panel. The backlight is disposed opposite a surface of the rear surface side polarizing plate that is not opposite the liquid crystal panel. In such a liquid crystal display device of a related art, one of methods of fixing the front surface side polarizing plate, the liquid crystal panel, the rear surface side polarizing plate, and the backlight each other is disclosed in Japanese Unexamined Patent Application Publication No. 2012-103687.

Japanese Unexamined Patent Application Publication No. 2012-103687 discloses an optical adhesive film used for a flat panel display module for displaying an image that includes a transmission part that is disposed on the flat panel display module for transmitting an image; and a blade part extending from one end of the transmission part for covering a side face of the flat panel display module and covering a part of a back face of the flat panel display module. The transmission part spontaneously adheres to a front face of the flat panel display module and the blade part spontaneously adheres to the side face and the back face of the flat panel display module.

### SUMMARY

The liquid crystal display device described in Patent Document 1 includes the optical adhesive film between the front surface side polarizing plate and the liquid crystal panel. Therefore, brightness of a displayed image is decreased according to the light transmittance of the optical adhesive film. Further, a thickness of the liquid crystal display device is increased by a thickness of the optical adhesive film. Furthermore, the method of producing the liquid crystal display device described in Patent Document 1 requires a process of attaching the optical adhesive film, and this increases a production cost. The present technology was made in view of the above circumstances and an object is to provide a liquid crystal display device that is high in brightness of a displayed image and has small thickness and a low production cost.

To solve the above problem, according to one aspect of the present technology, a liquid crystal display device includes a liquid crystal panel including two transparent substrates and a liquid crystal layer enclosing liquid crystals between the two transparent substrates, the liquid crystal panel having an alignment control region in which alignment of the liquid crystals is controlled, a polarizing plate disposed opposite a back surface of the liquid crystal panel, a backlight disposed opposite a surface of the polarizing plate that is not opposite the liquid crystal panel and supplying light to the polarizing plate, and an optical film including a front surface section and an extended section, the front surface section being disposed on a front surface of the liquid crystal panel, and the extended section extending from one edge of the front surface section and attached to at least a part of a side surface of the backlight or at least a part of a back surface of the backlight, and the front surface section includes in a part thereof a polarizing section that polarizes transmission light and the polarizing section overlaps the alignment control region.

According to the liquid crystal display device having such a configuration, the polarizing plate, the alignment control region, and the polarizing section are stacked on each other. Therefore, transmittance of light can be controlled based on the alignment direction of the liquid crystals. Therefore, light exiting through the backlight passes through the polarizing plate, the alignment control region and the polarizing section, and the brightness is varied according to the transmittance of the light. Accordingly, the brightness of a display screen can be controlled. Various images may appear on the display screen according to a purpose of the display screen.

According to the liquid crystal display device of the present technology, brightness of a displayed image is increased, a thickness of the device is decreased, and a production cost is reduced.

### BRIEF DESCRIPTION OF THE DRAWINGS

FIG. 1 is a perspective view of a liquid crystal display device according to a first embodiment.

FIG. 2 is an exploded view of the liquid crystal display device according to the first embodiment.

FIG. 3 is a cross-sectional view of the liquid crystal display device according to a first embodiment.

FIG. 4 is a cross-sectional view of a liquid crystal display device according to a second embodiment.

FIG. 5 is a plan view of a liquid crystal display device according to a third embodiment.

FIG. 6 is a development view of an optical film included in the liquid crystal display device according to the third embodiment.

FIG. 7 is a development view of an optical film included is a liquid crystal display device according to a fourth embodiment.

FIG. 8 is a development view of an optical film included in a liquid crystal display device according to a fifth embodiment.

FIG. 9 is a front view of a liquid crystal display device according to a sixth embodiment.

FIG. 10 is a development view of as optical film included in the liquid crystal display device according to the sixth embodiment.

FIG. 11 is a front view of a liquid crystal display device according to a seventh embodiment.

FIG. 12 is a development view of an optical film included in the liquid crystal display device according to the seventh embodiment.

FIG. 13 is a front view of a liquid crystal display device according to an eighth embodiment.

FIG. 14 is a development view of an optical film included in the liquid crystal display device according to the eighth embodiment.

FIG. 15 is a front view of a liquid crystal display device according to a ninth embodiment.

FIG. 16 is a development view of an optical film included in the liquid crystal display device according to the ninth embodiment.

FIG. 17 is a front view of a liquid crystal display device according to a tenth embodiment.

FIG. 18 is a development view of an optical film included in the liquid crystal display device according to the tenth embodiment.

FIG. 19 is a cross-sectional view of a liquid crystal display device according to an eleventh embodiment.

### DETAILED DESCRIPTION

### First Embodiment

<Liquid Crystal Display Device 100>

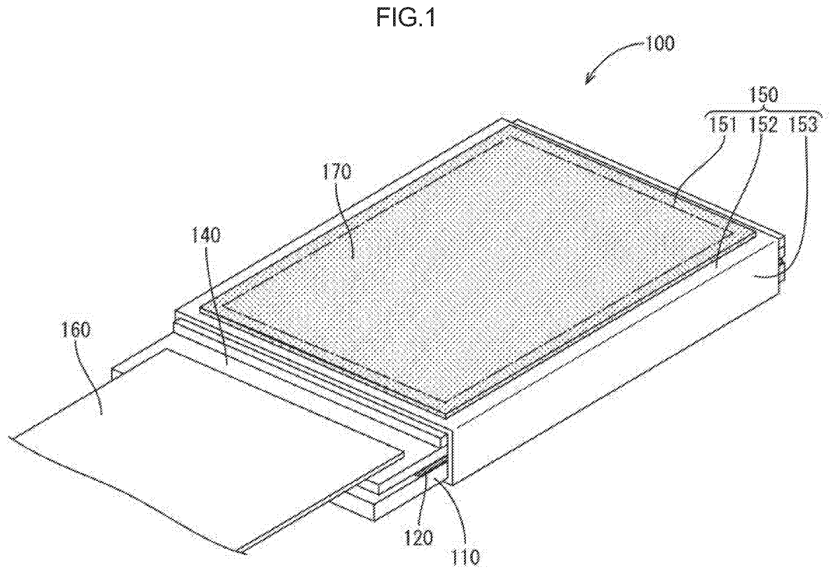

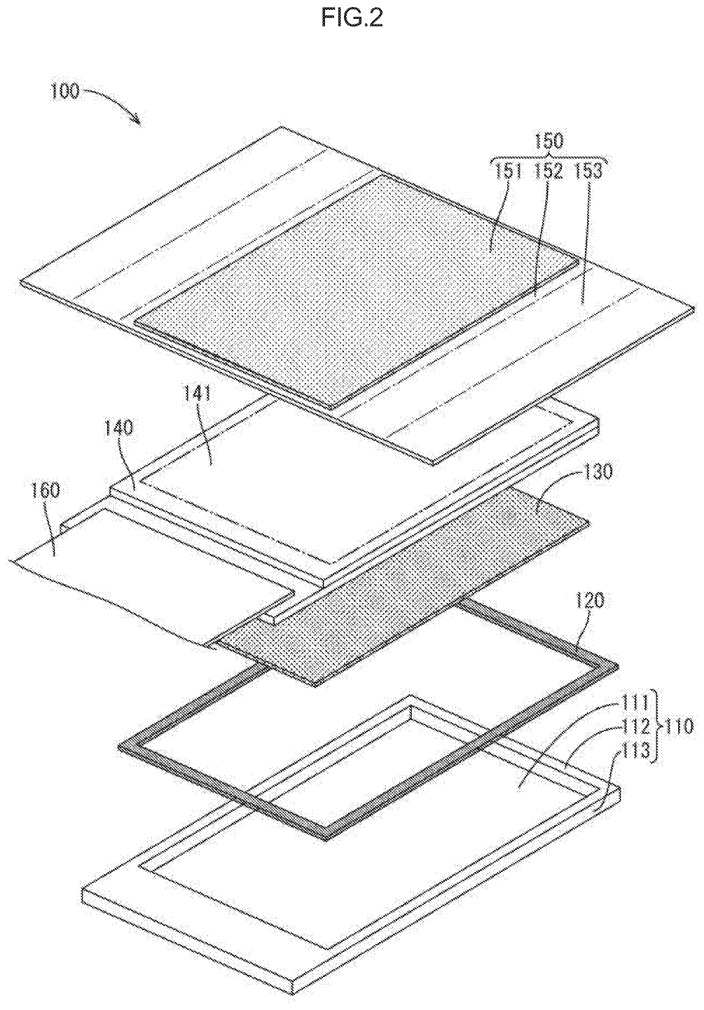

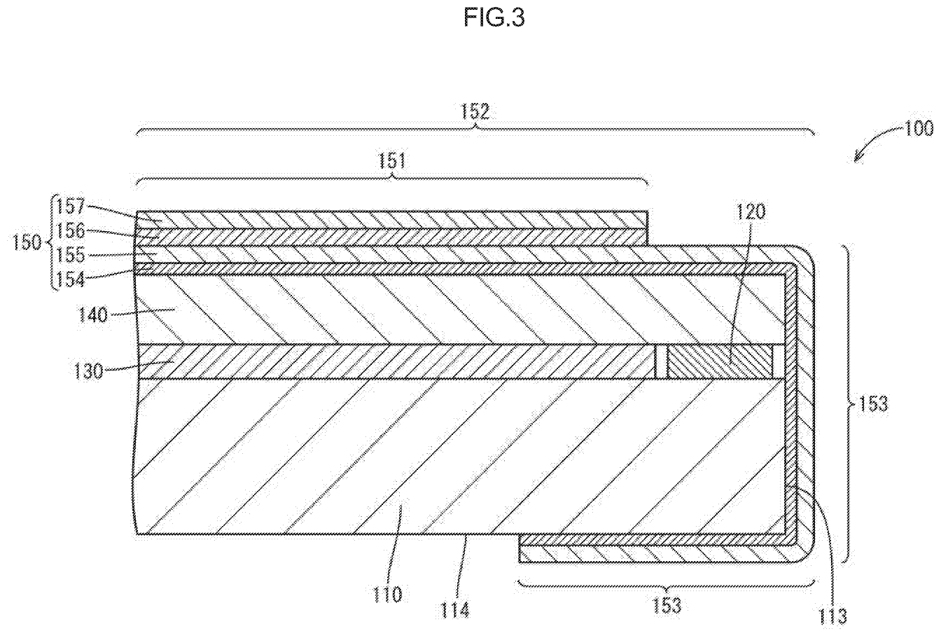

FIG. 1 is a perspective view illustrating the liquid crystal display device according to a first embodiment of the present technology. FIG. 2 is an exploded view of the liquid crystal display device 100 and FIG. 3 is a cross-sectional view of the liquid crystal display device 100. A configuration of the liquid crystal display device 100 will be described with reference to FIGS. 1, 2, and 3. In this specification, surfaces facing a direction same as a display surface displaying an image faces are referred to as front surfaces and surfaces facing an opposite side therefrom are referred to as back surfaces. Namely, in FIGS. 1 and 2, a surface facing an upper side is referred to as a front surface and a surface facing a lower side is referred to as a back surface. Surfaces facing other directions are referred to as side surfaces. The liquid crystal display device 100 includes a backlight 110, an adhesive tape 120, a polarizing plate 130, a liquid crystal panel 140, an optical film 150, and wirings 160.

<Liquid Crystal Panel 140>

The liquid crystal panel 140 includes two quadrangular transparent substrates and a liquid crystal layer that is between the two transparent substrates. The liquid crystal layer includes liquid crystals that are sealed with sealing material. The liquid crystal panel 140 has a plate shape. Material of the two transparent substrates is glass but may be other material such as plastic. Electrodes are arranged on a liquid crystal layer side section of the two transparent substrates and a potential difference therebetween can be controlled. The liquid crystals are aligned in a specific direction by the application of the potential difference between the electrodes. An alignment film may be provided on the liquid crystal layer side of the transparent substrate such that the liquid crystals are aligned in a certain direction when no potential difference is created between the electrodes. A spacer may provided to keep a constant distance between the two transparent substrates. The electrodes may be formed in any shape. For example, the electrodes may have an electrode pattern arrayed in a regular form or an electrode pattern of a graphic pattern, a character, or a picture. The alignment direction of the liquid crystals may be various directions such as a vertical alignment or a horizontal alignment. A transistor component may be included to control the potential difference between the electrodes.

Between the two transparent substrates, the front surface side transparent substrate has a long-side dimension that is small- than a long-side dimension of the back surface side transparent substrate. A front surface of one of the short-side sections of the back surface side transparent substrate is exposed outside. The liquid crystal layer is not disposed on the exposed section and a wiring 160 is connected thereto. Electric signals for controlling the alignment of the liquid crystals included in the liquid crystal panel 140 are transferred to the liquid crystal panel 140 through the wiring 160. The wiring 160 is a flexible circuit board including a flexible board and conductors printed thereon. The liquid crystal panel 140 controls the potential difference between the electrodes based on the electric signals supplied to the conductors of the wiring 160.

The liquid crystal panel 140 includes an alignment control region 141 where the alignment of the liquid crystals can be controlled. The liquid crystal layer is in the alignment control region 141 seen from the front surface side and an electric field is created by the potential difference in the region. The alignment control region has a quadrangular shape seen from the front surface side and is in a middle of the liquid crystal panel 140.

<Polarizing Plate 130>

The polarizing plate 130 is a flat plate having substantially same size and shape as the alignment control region 141 or slightly greater than that. The polarizing plate 130 has a function of polarizing light passing through a thickness thereof. The polarizing plate 130 of the present embodiment includes a polarizing layer and a protection layer. The polarizing layer is made of polyvinyl alcohol (PVA) as a main material has a polarizing function. The protection layer is disposed on front and back surfaces of the polarizing layer. The protection layer is a layer of one of triacetylcellulose (TAO), polyethylene terephthalate (PET), polypropylene (PP), and acrylic resin (resin containing poly (methyl methacrylate) as a main component) or a layer of mixture or stacking layers of two or more of triacetylcellulose, polyethylene terephthalate, polypropylene, and acrylic resin. However, the material is not limited to the above. The polarizing plate 130 is disposed opposite the back surface of the liquid crystal panel 140 to cover the alignment control region 141 with a pressure sensitive adhesive layer or an adhesive layer.

<Backlight 110>

The backlight 110 has a quadrangular plate shape having a substantially same shape as that of the liquid crystal panel 140 seen from the front surface side. The backlight 110 includes a light exit region 111 through which the light exits. The light exit region 111 preferably has a substantially same shape as that of the alignment control region 141 seen from the front surface side. A region of the front surface of the backlight 110 that is outside the light exit region 111 is referred to as a frame region 112. The backlight 110 is disposed opposite a surface of the polarizing plate 130 that is not opposite the liquid crystal panel 140, that is, disposed opposite a back surface.

<Adhesive Tape 120>

The backlight 110 and the liquid crystal panel 140 are fixed to each other with the adhesive tape 120. The adhesive tape 120 has a quadrangular shape having a quadrangular hole in a middle thereof and has a frame shape. The polarizing plate 130 is arranged in the hole. The front surface of the adhesive tape 120 adheres to a section of the back surface of the liquid crystal panel 140 and outside the alignment control region 141. The back surface of the adhesive tape 120 adheres to the frame region 112 of the backlight 10. The adhesive tape 120 at least fixes the liquid crystal panel 140 and the backlight 110 and may not be formed in the frame shape. For example, four side sections of the frame region 112 may be fixed with thin and long strips of adhesive tapes or only a part of the frame region 112 may be fixed with the adhesive tape. Further, as long as the liquid crystal panel 140 and the backlight 110 are fixed to each other effectively, fixing means other than the adhesive tape 120 such as fixing with screws may be used. If the liquid crystal panel 140 and the backlight 110 are effectively fixed to each other only with the optical film 150, which will be described later, such fixing means is not necessary.

<Optical Film 150>

As illustrated in FIG. 2, the optical film 150 is a quadrangular film and includes a front surface section 152 and an extended section 153. The front surface section 152 is attached to the front surface of the liquid crystal panel 140. The extended section 153 extends from the long side of the front surface section 152. A polarizing section 151 is included in a middle section of the front surface section 152. The extended section 153 at least extends from two sides of the front surface section 152.

The polarizing section 151 has a function of polarizing the light passing through the thickness of the optical film 150. The polarizing section 151 has a quadrangular shape having a substantially same size and shape as or greater than those of the alignment control region 141 seen from the back surface side so as to cover the alignment control region 141.

The optical film 150 is foldable at a border between the front surface section 152 and the extended section 153 and at a section of the extended section 153. As illustrated in FIGS. 1 and 3, the optical film 150 is folded at a front surface side edge of the liquid crystal panel 140 toward the back surface such that the extended section 153 is in contact with the side surface of the liquid crystal panel 140 and the side surface 113 of the backlight 110. Further, the optical film 150 is further folded at a back surface side edge of the backlight 110 such that the extended section 153 is contacted with the back surface 114 of the backlight 110. The optical film 150 has a pressure sensitive adhesive layer 154 on the back surface side thereof. Therefore, the optical film 150 is fixed to the front surface and the side surface of the liquid crystal panel 140 and further fixed to the side surface 113 and the back surface 114 of the backlight 110. Accordingly, the liquid crystal panel 140 and the backlight 110 are firmly connected to each other.

A configuration of the optical film 150 will be described with reference to FIG. 3. In the following description of the optical film 150, the terms of “a front surface” and “a back surface” represent “the from surface” and “the back surface” before the extended section 153 is folded. The optical film 150 includes the adhesive layer 154, a first protection layer 155, a polarizing layer, and a second protection layer 157 that are stacked on each other in this order from the back surface side.

The first protection layer 155 is preferably made of material that is transparent with respect to visible light and has certain tensile strength, hardness, a chemical resistance property, an ultraviolet absorbing property, and flexibility. Specifically, examples of the material include one of triacetylcellulose, polyethylene terephthalate, polypropylene, and acrylic resin or a layer of mixture or stacking layers of two or more of triacetylcellulose, polyethylene terephthalate, polypropylene, and acrylic resin. A surface of the first protection layer may be subjected to a hard coating process, an antiglare process, a low reflection process, and an antistatic process, if necessary.

The adhesive layer 154 is disposed on the back surface side of the first protection layer 155. As is described before, the adhesive layer 154 is used for bonding the optical film 150 to the liquid crystal panel 140 and the backlight 110. The adhesive layer 154 may be an adhesive layer.

In a section of the optical film 150 corresponding to the polarizing section 151, the polarizing layer 156 is bonded to the front surface of the first protection layer 155 with adhesive. The polarizing layer 156 has a function of polarizing the light that passes through the thickness of the polarizing layer 156. Specifically, the polarizing layer 156 is preferably made of material obtained by absorbing and aligning iodine (I) compound in polyvinyl alcohol.

Further, the second protection layer 157 is bonded to the front surface of the polarizing layer 156 with adhesive. The second protection layer 157 is preferably made of material that is transparent with respect to visible light and has certain tensile strength, hardness, a chemical resistance property, an ultraviolet absorbing property, and flexibility. Specifically, examples of the material include one of triacetylcellulose, polyethylene terephthalate, polypropylene, and acrylic resin or a layer of mixture or stacking layers of two or more of triacetylcellulose, polyethylene terephthalate, polypropylene, and acrylic resin. A surface of the first protection layer may be subjected to a hard coating process, an antiglare process, a low reflection process, and an antistatic process, if necessary.

<Advantageous Effects of the Present Embodiment>

According to the liquid crystal display device 100 according to the present embodiment, the polarizing plate 130, the alignment control region 141, and the polarizing section 151 are stacked on (overlapped with) each other. Therefore, transmittance of light can be controlled based on the alignment direction of the liquid crystals. Therefore, light exiting through the light exit region 111 of the backlight 110 passes through the polarizing plate 130, the alignment control region 141 and the polarizing section 151, and the brightness of exiting light is varied according to the transmittance of the light. Accordingly, the brightness of the display screen can be controlled. The region through which the light exits with controlled brightness is referred to as a display screen 170. Various images may appear on the display screen 170 according to a purpose of the display screen.

The optical film 150 is folded to extend and adhere to the front surface of the liquid crystal panel 140 and the side surface 113 of the backlight 110. Therefore, the liquid crystal panel 140 and the backlight 110 are fixed to each other with a simple and lightweight structure. The optical film 150 is folded to extend to the back surface 114 of the backlight 110 such that the liquid crystal panel 140 and the backlight 110 are fixed to each other more firmly.

The extended section 153 may not be folded at the back surface side edge of the backlight 110 so as to be contacted with the back surface 114. The extended section 153 may not be fixed to the back surface 114 of the backlight 110. In such a configuration, the extended section 153 may be smaller and this leads to decrease in weight, thickness, and cost. Furthermore, the production process is simplified and this leads to cost reduction.

According to the configuration of bonding the extended section 153 to the back surface 114 of the backlight, the liquid crystal panel 140 and the backlight 110 are fixed to each other and therefore, the extended section 153 may not be necessary to be fixed to the side surface 113 of the backlight. In such a configuration, the extended section 153 provided on the side surface does not necessarily include the adhesive layer 154 and this may lead to decrease in size, weight, and cost.

The front surface side polarizing plate and the optical adhesive film are integrally formed into the optical film 150. Therefore, the liquid crystal display device can be decreased in thickness, weight, and cost compared to a configuration including a front surface side polarizing plate and an optical adhesive film as separate components. Further, compared to an optical film obtained by overlapping the front surface side polarizing plate and the optical adhesive film, the optical film of the present embodiment has higher transmittance and therefore, brightness of the display screen 170 can be increased and the power consumption is reduced.

The extended section 153 does not include the polarizing layer 156 and/or the second protection layer 157. Therefore, the extended section 153 is easy to be folded and is light and thin. Therefore, the process of folding the extended section 153 is easy and the liquid crystal display device 100 is thinner and lighter. The front surface section 152 may have the polarizing layer 156 and/or the second protection layer 157 over an entire area thereof. The extended section 153 may have the polarizing layer 156 and/or the second protection layer 157 on a part thereof or an entire area thereof. In such a configuration, producing and attachment of the optical film 150 may become easier or the optical film 150 may be stronger. The entire front surface area of the liquid crystal display device 100 is a flat surface and the display screen 170 is less likely to be distinguished from the section around the display screen 170 where no image is displayed and this improves design.

The alignment control region 141 of the liquid crystal panel 140, the polarizing plate 130, the light exit region 111 of the backlight 110, and the polarizing section 151 of the optical film 150 may at least have an overlapping area seen from the front surface side and do not necessarily have the same shape and do not necessarily have a quadrangular shape. However, if the alignment control region 141 of the liquid crystal panel 140, the polarizing plate 130, the light exit region 111 of the backlight 110, and the polarizing section 151 of the optical film 150 may have a substantially same shape and overlap each other over substantially entire areas seen from the front surface side, a non-overlapping area is decreased. As a result, an area of the display screen 170 is increased and the area around the display screen 170 where no image is displayed is decreased and such a configuration is more preferable.

### Second Embodiment

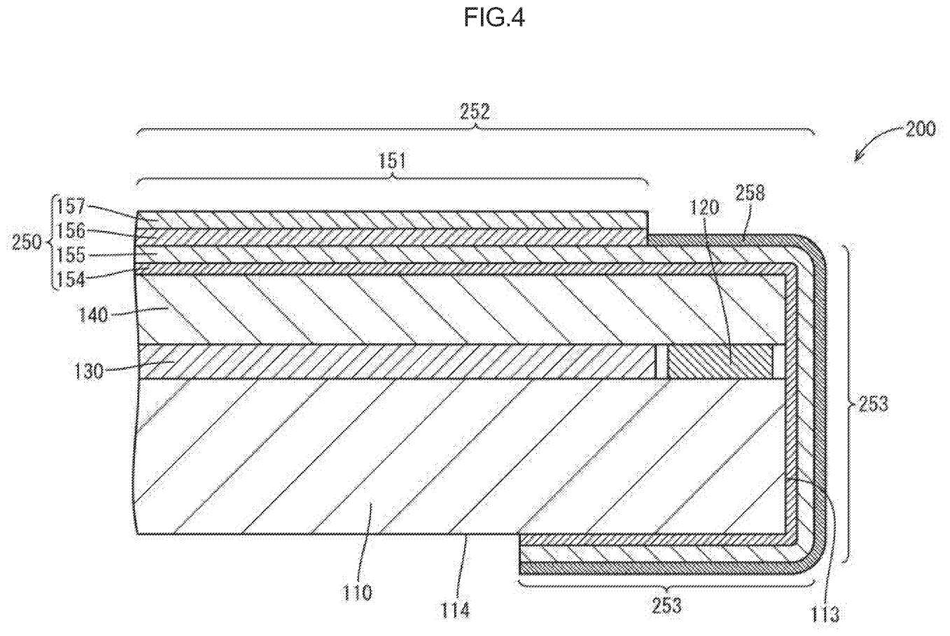

FIG. 4 is a cross-sectional view of a liquid crystal display device 200 according to a second embodiment of the present technology. Components same as those of the first embodiment are provided with the same symbols and the components and configurations same as those of the first embodiment will not be described. An optical film 250 of the liquid crystal display device 200 according to the present embodiment includes a front surface section 252 and an extended section 253. The front surface section 252 is attached to and disposed on the front surface of the liquid crystal panel 140. The extended section 253 extends from one edge of the front surface section 252. Similarly to the optical film 150, the front surface section 252 includes the polarizing section 151. The adhesive layer 154, the first protection layer 155, the polarizing layer 156, and the second protection layer 157 are stacked on each other in this order from the back surface side.

Further, the optical film 250 includes a light blocking layer 258 on the front surface of the first protection layer 155 in an area having no polarizing layer 156. A large amount of the visible light rays supplied to the light blocking layer 258 do not transmit therethrough. The light blocking layer may be a light absorbing layer or a light reflection layer or may have a multilayer structure including the light reflection layer and the light absorbing layer. Most of the visible light rays supplied to the light blocking absorbing layer are absorbed by the light absorbing layer and the light absorbing layer is preferably formed by coating black ink. Most of the visible light rays supplied to the light reflection layer are reflected by the light reflection layer and a typical example thereof may be an aluminum thin film.

According to the present embodiment, the light exiting the backlight 110 is reflected and refracted within the liquid crystal display device 200 and stray light may be created and such stray light is less likely to exit the liquid crystal display device 200 through sections other than the display screen 170.

The light blocking layer 258 may not be necessarily formed on an entire area having no polarizing layer 156. However, the light blocking layer 258 is preferably formed on the entire area having no polarizing layer 156. According to the configuration including the light blocking layer 258 on the entire area having no polarizing layer 156, the stray light is further less likely to exit through the sections other than the display screen 170. According to the configuration including the light blocking layer 258 on only a part of the area having no polarizing layer 156, the device may be reduced in weight, thickness, and a cost.

The light blocking layer 258 is preferably not formed on a front side of the polarizing layer 156. According to the configuration not including the light blocking layer 258 on the front side of the polarizing layer 156, the entire area having the polarizing layer 156 can be used as the display screen 170 of the liquid crystal display device 200. The light blocking layer 258 may be formed on the front side of the polarizing layer 156. In designing of such a configuration, the polarizing layer 156 and the light blocking layer 258 may overlap each other. Therefore, even if the position of the polarizing layer 156 or the light blocking layer 258 is shifted in the production process, an area having no polarizing layer 156 and no light blocking layer 258 is less likely to be created and the stray light is less likely to exit outside.

The light blocking layer 258 that is made of material having conductivity such as an aluminum thin film has an effect of protection against electromagnetic wave. Further, the light blocking layer 258 that is made of material having high light reflectance such as an aluminum thin film can reflect the stray light toward the inner side of the liquid crystal display device 200. This increases brightness of the display screen 170. Further, if material having high light absorbing rate such as black ink is disposed on the front surface of the material having high light reflectance (on an outer side of the liquid crystal display device 200), the stray light is further less likely to exit outside.

### Third Embodiment

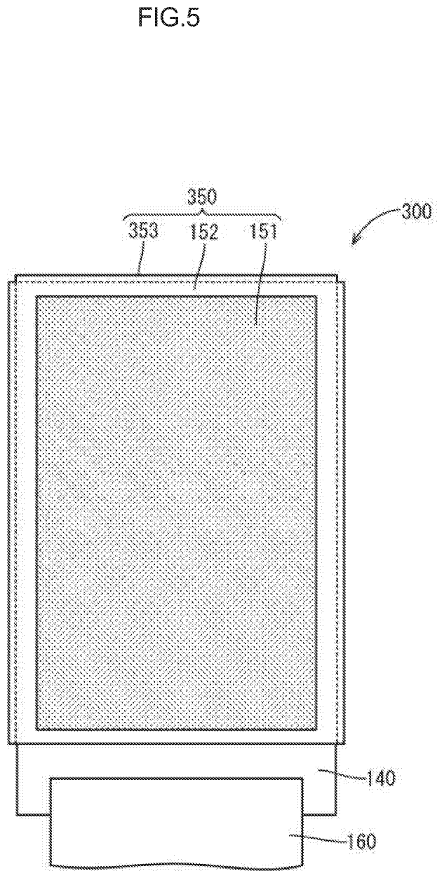

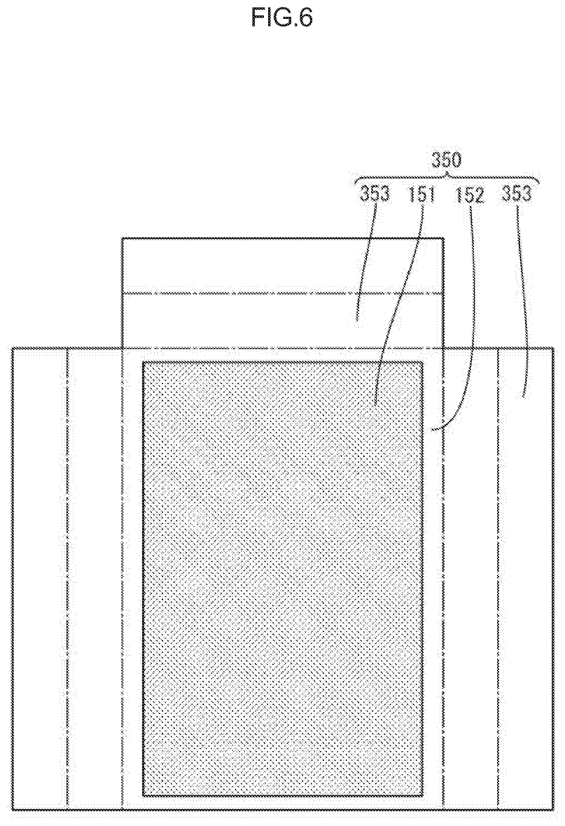

FIG. 5 illustrates a plan view of a liquid crystal display device 300 according to a third embodiment. FIG. 6 illustrates a development view of an optical film 350 included in the liquid crystal display device 300 according to the third embodiment. Components same as those of the first embodiment are provided with the same symbols and the components and configurations same as those of the first embodiment will not be described.

The optical film 350 of the present embodiment includes extended sections 353 extending from three sides of the front surface section 152. The extended sections 353 are attached to three side surfaces of the liquid crystal panel 140 where the wiring 160 is not connected, the three side surfaces 113 and the back surface 114 of the backlight 110.

According to the present embodiment, the optical film 350 is attached to the three side surfaces of the liquid crystal panel 140 where the wiring 160 is not connected, the three side surfaces 113 and the back surface 114 of the backlight 110. Therefore, the liquid crystal panel 140 and the backlight 110 are fixed to each other more firmly. The extended sections 353 may have a light blocking layer thereon and accordingly, the stray light is blocked more surely.

### Fourth Embodiment

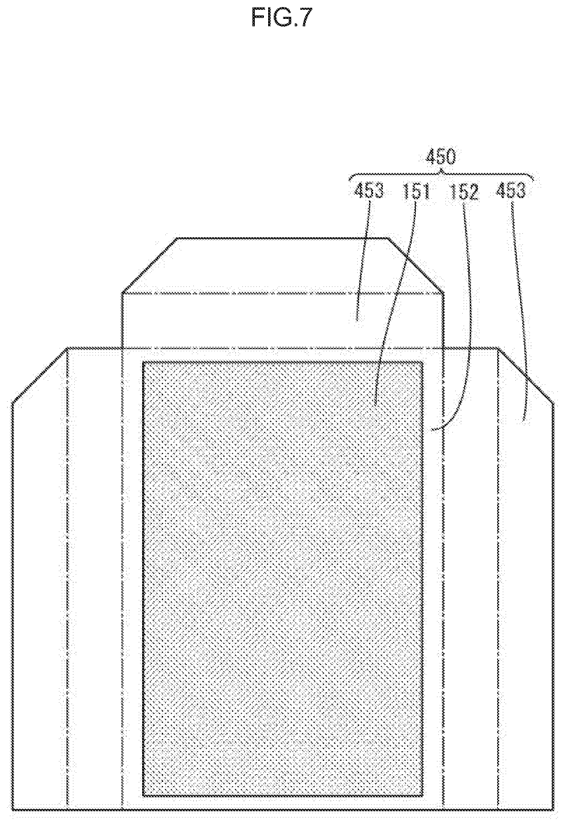

FIG. 7 illustrates a development view of an optical film 450 included in a liquid crystal display device according to a fourth embodiment of the present technology. Components same as those of the third embodiment are provided with the same symbols and the components and configuration same as those of the third embodiment will not be described. An extended section 453 of the optical film 450 has a shape obtained by cutting off corners of the extended section 353 of the optical film 350 obliquely at an angle of 45 degrees. According to the present embodiment, when attaching the optical film 450 to the back surface 114 of the backlight 110, the extended section 453 on the long side does not overlap the extended section 453 on the short side on the back surface 114 side of the backlight 110. Therefore, the liquid crystal display device can be reduced in thickness and the backlight 110 can keep flatness of the back surface 114.

### Fifth Embodiment

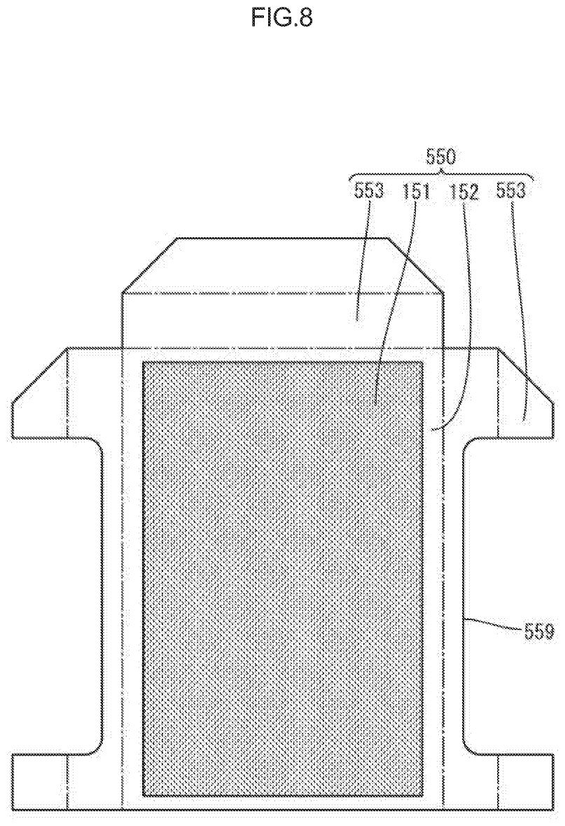

FIG. 8 illustrates a development view of as optical film 550 included in a liquid crystal display device according to a fifth embodiment of the present technology. Components same as those of the fourth embodiment are provided with the same symbols and the components and configuration same as those of the fourth embodiment will not be described. An extended section 553 of the optical film 550 has a recess 559 in the extended section 453 of the optical film 450. According to the present embodiment, the optical film 550 including the recess 559 that corresponds to an opening of the liquid crystal display device. This may reduce a weight of the device, improve heat dissipation, and simplify a process of attaching the optical film 550 to the liquid crystal panel 140 and the backlight 110.

### Sixth Embodiment

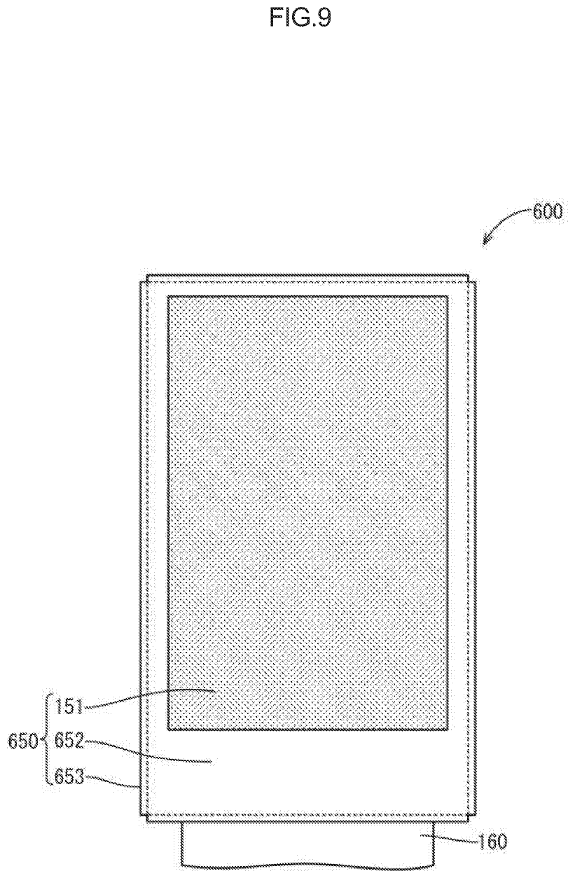

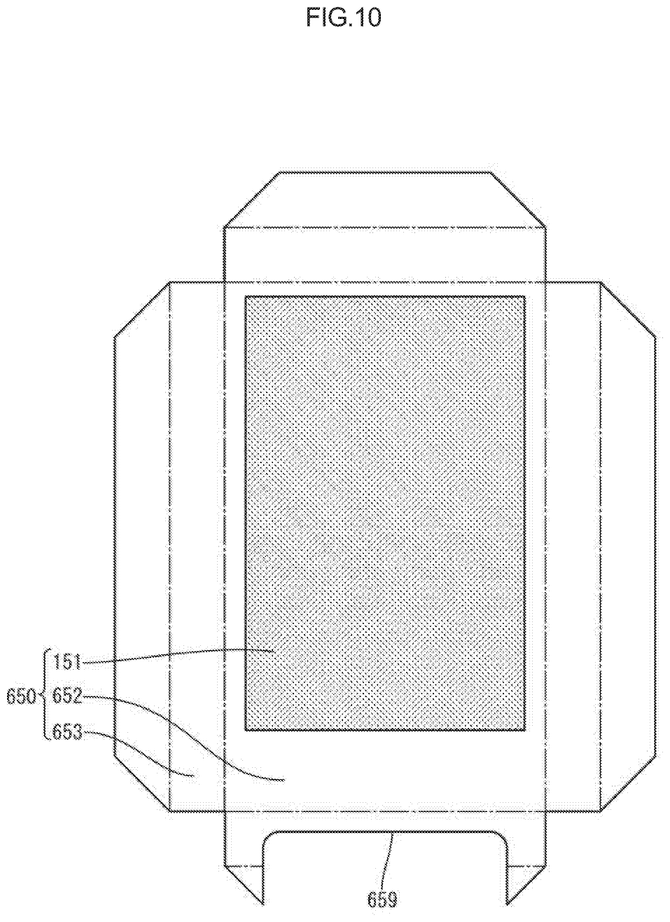

FIG. 9 illustrates a liquid crystal display device 600 according to a sixth embodiment of the present technology. FIG. 10 illustrates a development view of as optical film 650 included in the liquid crystal display device 600. Components same as those of the fourth embodiment are provided with the same symbols and the components and configuration same as those of the fourth embodiment will not be described.

As illustrated in FIG. 10, the optical film 650 includes a front surface section 652 having a rectangular shape and a whole liquid crystal panel 140 can be covered with the optical film 650 from the front side. An extended section 653 extends from each side of the front surface section 652. The extended section 653 includes a recess 659. As illustrated in FIG. 9, an entire area of the front surface of the liquid crystal panel 140 is covered with the optical film 650 and the extended sections 653 are attached to the four side surfaces of the liquid crystal panel 140 and the four side surfaces 113 and the back surface 114 of the backlight 110, respectively. The recess 659 of the optical film 650 corresponds to an opening of the liquid crystal display device 600 and the wiring 160 extends through the opening to the outside.

According to the present embodiment, the optical film 650 is attached to the four side surfaces of the liquid crystal panel 140 and the four side surfaces 113 and the back surface 114 of the backlight 110. Therefore, the liquid crystal panel 140 and the backlight 110 are fixed to each other more firmly. Further, the recess 659 corresponds to the opening of the liquid crystal display device 600 and the wiring 160 passes through the opening such that the wiring 160 connected to the liquid crystal panel 140 extends to the outside of the liquid crystal display device 600. Further, a light blocking layer may be provided in a section of the optical film 150 having no polarizing layer. In such a configuration, the stray light can be blocked more surely. The wiring 160 may not be the one connected to the liquid crystal panel 140 but may be connected to the backlight 110 or may be disposed on the front surface side of the liquid crystal panel 140 and the back surface side of the front surface section and connected to a touch panel.

### Seventh Embodiment

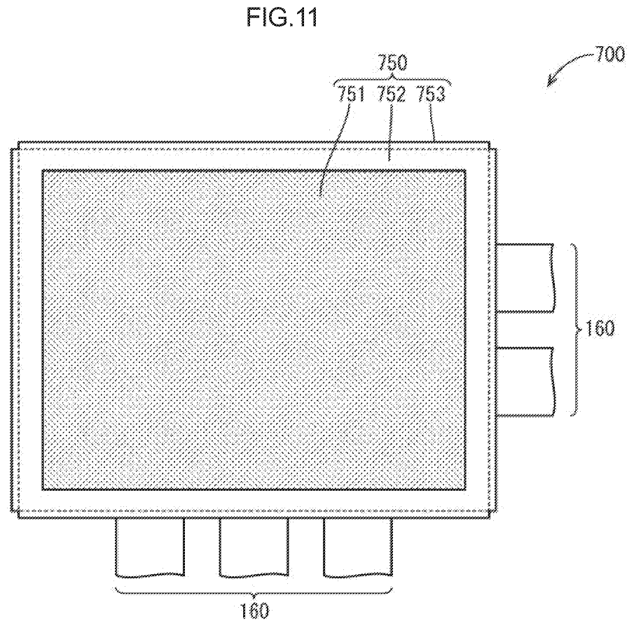

FIG. 11 illustrates a liquid crystal display device 700 according to a seventh embodiment of the present technology. Components same as those of the sixth embodiment are provided with the same symbols and the components and configuration same as those of the sixth embodiment will not be described. The liquid crystal display device 700 of this embodiment has a laterally elongated quadrangular shape seen from the front surface side and includes five wirings 160. Two of the five wirings 160 are connected to the short side edge, which is on a right side in the drawing, of the liquid crystal panel and the other three of the wirings 160 are connected to the long side edge, which is on a lower side in the drawing. The front surface of the liquid crystal display device 700 is covered with an optical film 750 except for the wirings 160.

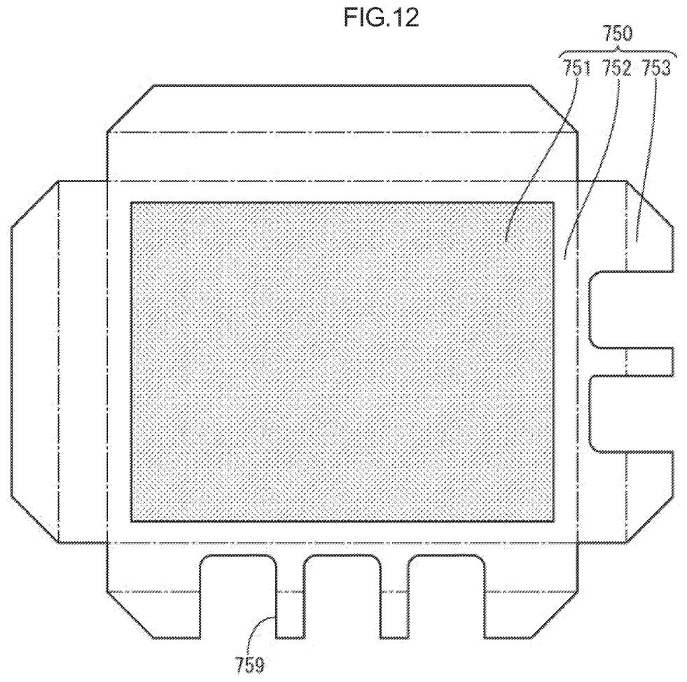

FIG. 12 illustrates a development view of the optical film 750 included in the liquid crystal display device 700. The optical film 750 includes a front surface section 742 and extended sections 753. The front surface section 742 has a laterally elongated quadrangular shape that covers the liquid crystal panel. The extended sections 753 extend from four sides of the front surface section 752, respectively, toward the outside. The front surface section 752 includes a polarizing section 751 of a laterally elongated quadrangular shape having a substantially same size as that of the alignment control region of the liquid crystal panel. The extended sections 753 have five recesses 759. The recesses 759 correspond to openings of the liquid crystal display device 700 and the wirings 160 are extended through the respective openings.

According to the present embodiment, in the liquid crystal panel 140 having a short side section and/or a long side section where the wiring 160 is connected, the wiring 160 can extend to the outside of the liquid crystal panel 140. Multiple wirings 160 can extend outside the liquid crystal panel 140. In the present embodiment, two wirings 160 are connected to one of the short side sections of the liquid crystal panel 140 and three wirings 160 are connected to one of the long side sections of the liquid crystal panel 140. However, the sections of the liquid crystal panel 140 where the wirings 160 are connected are not limited to the above sections. For example, the wirings 160 may be connected to opposing two side sections of the liquid crystal panel 140 or may be connected to three side sections or four side sections. The number of the wirings 160 is not limited but necessarily one or more.

### Eighth Embodiment

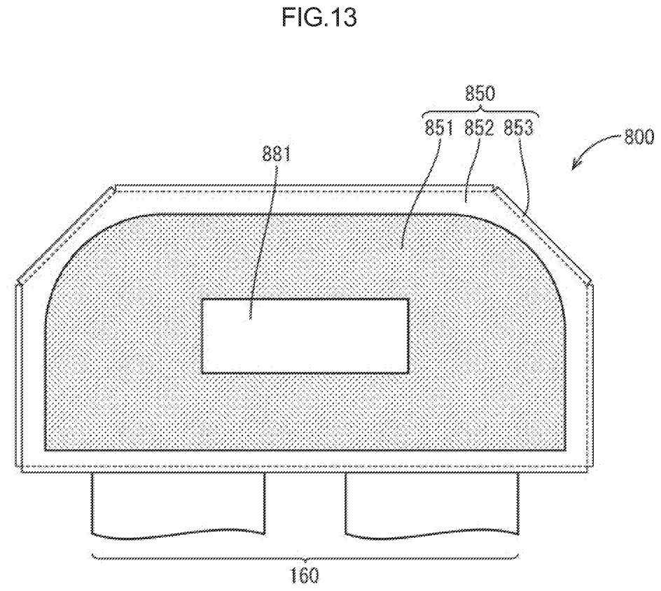

FIG. 13 illustrates a liquid crystal display device 800 according to an eighth embodiment of the present technology. Components same as those of the seventh embodiment are provided with the same symbols and the components and configuration same as those of the seventh embodiment will not be described. The liquid crystal display device 800 of the present embodiment has a shape obtained by cutting off right and left upper corners of a substantially laterally elongated quadrangular shape seen from the front surface side obliquely at an angle of 45 degrees (a shape with chamfering). Two wirings 160 are provided. The two wirings 160 are connected to the lower long side section in the drawing. The front surface of the liquid crystal display device 800 is covered with an optical film 850.

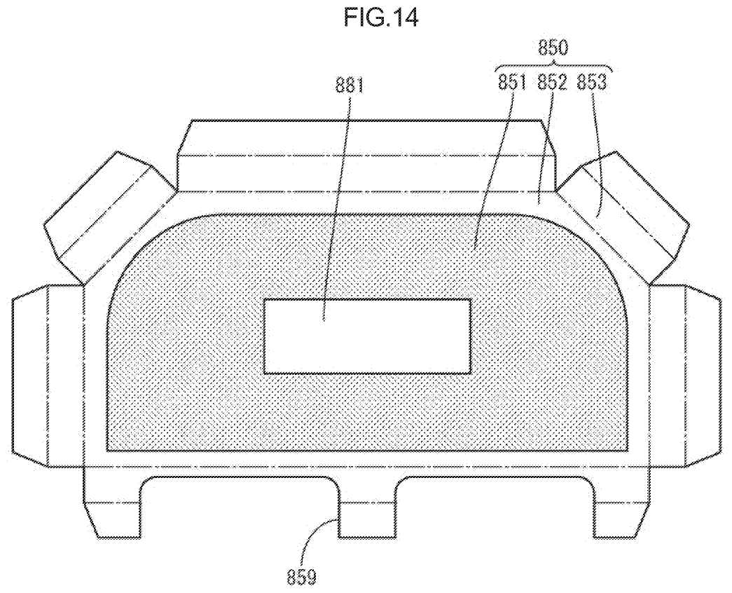

FIG. 14 illustrates a development view of the optical film 850 included in the liquid crystal display device 800 according to the present embodiment. The optical film 850 of the present embodiment includes a front surface section 852 and extended sections 853. The front surface section 852 has a shape obtained by cutting off right and left upper corners of the substantially laterally elongated quadrangular shape obliquely at an angle of 45 degrees (a shape with chamfering). The front surface section 852 includes a polarizing section 851 in a middle section thereof. The polarizing section 851 has an outline having round corners R at right and left upper corners of the elongated quadrangular shape. The polarizing section 851 includes a transparent window 881 in a middle section thereof. No polarizing section 151 is provided in the transparent window 881 and does not have a function of polarizing the transmission light. The extended section 853 extending from each of the side sections of the front surface section 852 has two recesses 859. The recesses 859 correspond to openings of the liquid crystal display device 800 and the wirings 160 extend through the openings.

A liquid crystal panel according to the present embodiment has an outline having a substantially same shape as or slightly smaller than the shape of the front surface section 852 seen from the front surface side. The alignment control region of the liquid crystal panel has a substantially same shape as that of the polarizing section 851. The section of the liquid crystal panel that corresponds to a back surface of the transparent window may be or may not be the alignment control region. The outline of a polarizing plate of the present embodiment is a substantially same shape as that of the polarizing section 851 seen from the front surface side. The section of the polarizing plate that is positioned on the back surface side of the transparent window 881 does not have the function of polarizing the transmission light. The backlight is disposed on the back surface side of the polarizing plate. The backlight has a substantially same shape as or slightly smaller than that of the front surface section 852. The backlight does not include a reflector, a diffuser, or a chassis on the section on the back surface side of the transparent window 881.

According to the present embodiment, in the transparent window 881, the sections of optical film 850 and the polarizing plate positioned on the back surface side of the optical film 850 do not have a function of polarizing the transmission light. Therefore, even if the alignment direction of the liquid crystals of the liquid crystal panel is controlled, the transmittance of the light rays transmitting through the optical film 850, the liquid crystal panel, and the polarizing plate is high and is less likely to change. In the backlight disposed on the back surface side of the polarizing plate, a section that is on the back surface side of the transparent window 881 does not include the reflector, the diffuser and the chassis. Therefore, the backlight can be seen through to the rear surface side thereof. The section of the polarizing plate that is positioned on the back surface side of the transparent window 881 may be formed in a hole.

### Ninth Embodiment

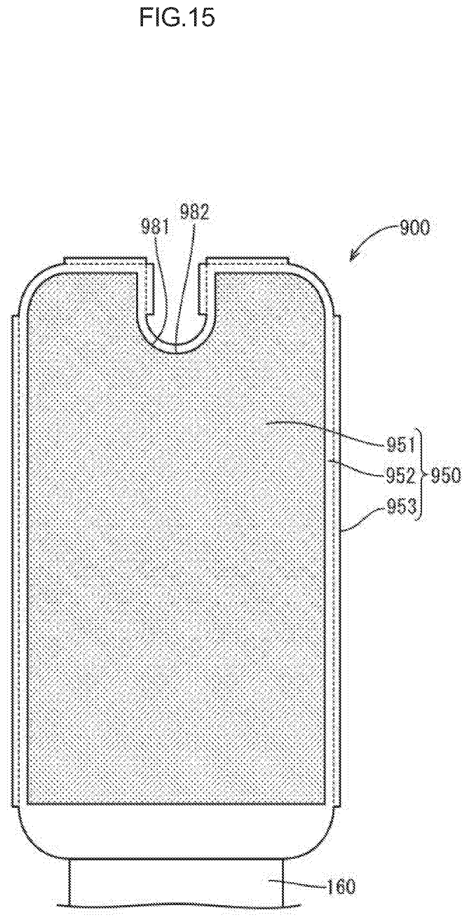

FIG. 15 illustrates a liquid crystal display device 900 according to a ninth embodiment of the present technology. Components same as those of the third embodiment are provided with the same symbols and the components and configuration same as those of the third embodiment will not be described. The liquid crystal display device 900 has a shape obtained by forming round corners R at four corners of a substantially vertically elongated quadrangular shape seen from the front surface side and further includes a recess 982. The recess 982 is formed in a slit shape having a round distal end. The liquid crystal display device 900 includes the wiring 160. The wiring 160 is connected to the short side edge section that is on the lower side in the drawing. The front surface of the liquid crystal display device 900 is covered with the optical film 950 except for edges of the four corners R and a semicircular edge of the distal end of the recess 982. The polarizing section 951 is disposed in a middle section of the optical film 950. The polarizing section 951 has a shape obtained by providing round corners R at the four corners of the vertically elongated quadrangular shape and cutting off the section corresponding to the recess 982 and forming a recess 981.

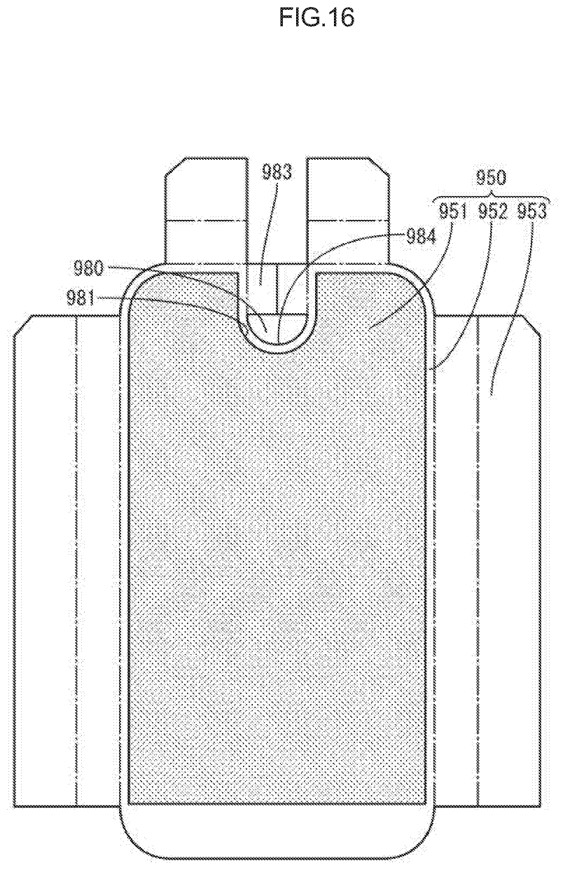

FIG. 16 illustrates a development view of the optical film 950 included in the liquid crystal display device 900 according to the present embodiment. The optical film 950 of the present embodiment includes a front surface section 952 and extended sections 953. The front surface section 952 has a shape obtained by providing round corners at the four corners of the vertically elongated quadrangular shape and providing a recess 984 at the section corresponding to the recess 982. The extended sections 953 extend from those of the peripheral straight sections of the front surface section 952 except for the lower straight section in the drawing. The extended section 983 also extends from the peripheral straight section of the recess 984. The extended section 953 does not extend from the semicircular edge of the recess 984 and a hole 980 is formed there.

In the present embodiment, not only the front surface section 952 but also the liquid crystal panel, the polarizing plate, and the backlight that are disposed on the back surface side of the front surface section 952 are provided with round corners at the four corner of the vertically elongated quadrangular shape and a recess is formed in the section corresponding to the recess 982.

According to the present embodiment, the liquid crystal display device 900 is formed into a quadrangular shape having round corners R. Further, the recess 982 is formed in the device. The display screen is formed into a quadrangular shape having round corners. The recess is formed in the display screen. Since the outline of the liquid crystal display device 900 seen from the front surface side is similar to the shape of the display screen, most area of the front surface of the liquid crystal display device 900 can be used as the display screen. The shape and the number of the recesses 982, the size of the corner R, and a ratio of a vertical dimension and a horizontal dimension of a whole device may be altered in design as necessary.

### Tenth Embodiment

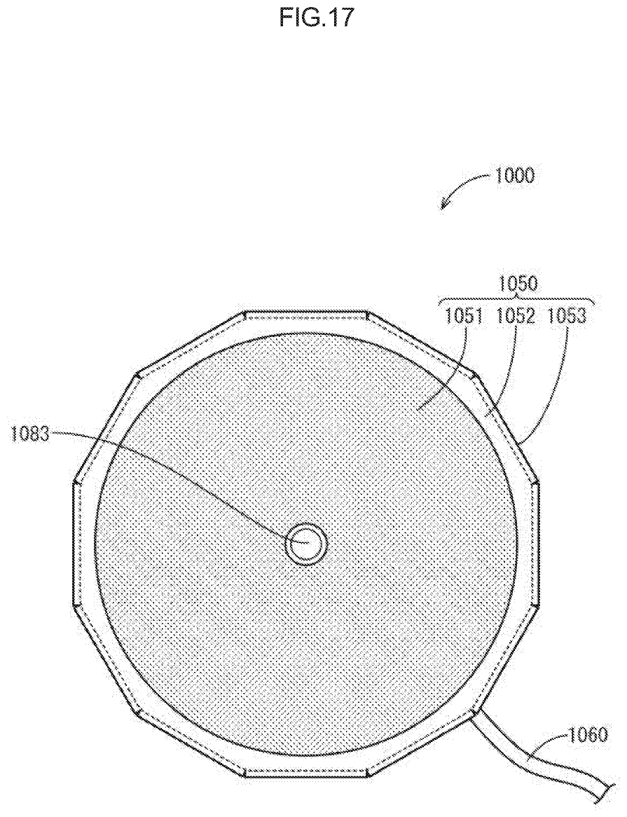

FIG. 17 illustrates a liquid crystal display device 1000 according to a tenth embodiment of the present technology. Components same as those of the third embodiment are provided with the same symbols and the components and configuration same as those of the third embodiment will not be described. The liquid crystal display device 1000 of the present embodiment has a substantially regular twelve-sided polygonal shape having a through hole 1083 at a center thereof seen from the front surface side. The liquid crystal display device 1000 includes a wiring 1060. The wiring 1060 has a linear shape having a substantially circular cross section. The wiring 1060 extends outside from an apex section of the regular twelve-sided polygonal shape among the side surfaces of the liquid crystal display device 1000 seen from the front surface side. The front surface of the liquid crystal display device 1000 is covered with a front surface section 1052 of an optical film 1050 and a part of a side surface and a back surface thereof are covered with extended sections 1053. The front surface section 1052 includes a circular polarizing section 1051 in a middle thereof and has the through hole 1083 at a center thereof.

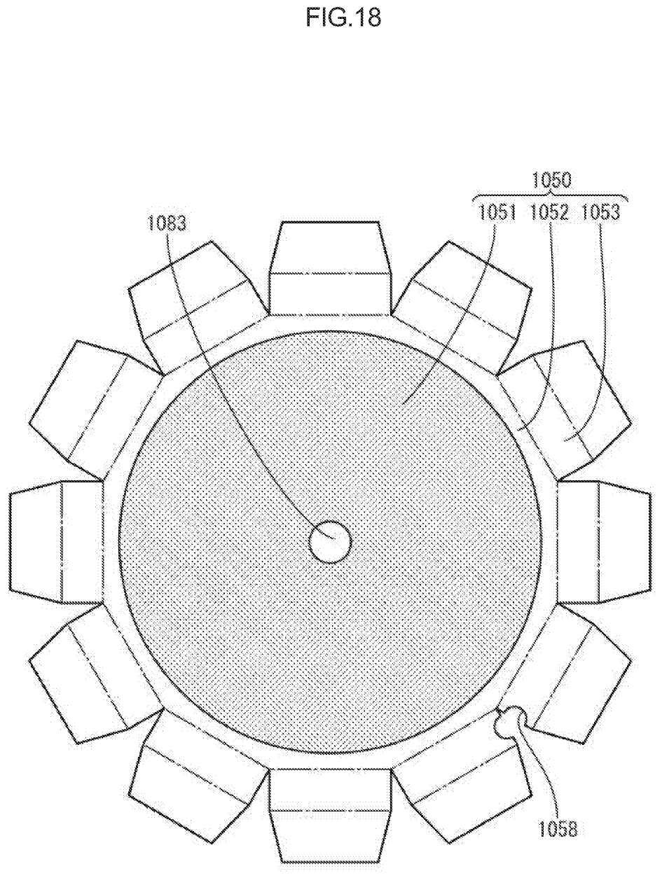

FIG. 18 illustrates a development view of the optical film 1050 included in the liquid crystal display device 1000 according to the present embodiment. The optical film 1050 of the present embodiment includes a front surface section 1052 and twelve extended sections 1053. The front surface section 1052 has the through hole 1083 (opening) at a center of the regular twelve-sided polygonal shape. The extended sections 1053 extend from the respective sides of the regular twelve-sided polygonal shape of the front surface section 1052. The extended sections 1053 have a recess 1058 that is to be a circular hole when being attached to the liquid crystal display device 1000.

A liquid crystal panel is disposed on the back surface side of the optical film 1050. The liquid crystal panel has a substantially regular twelve-sided polygonal shape seen from the front surface side similar to the front surface section 1052 and has a through hole at a center thereof. The alignment control region has a circular shape similar to that of the polarizing section 1051. A polarizing plate is disposed on the back surface side of the liquid crystal panel. The polarizing plate has a substantially circular shape seen from the front surface side and has a through hole at a center thereof. A backlight is disposed on the back surface side of the polarizing plate. The backlight has a substantially regular twelve-sided polygonal shape seen from the front surface side similar to that of the front surface section 1052. The front surface section 1052 has a through hole at a center thereof.

According to the present embodiment, the liquid crystal display device 1000 has a regular twelve-sided polygonal shape and the display screen may have a circular shape. Further, the liquid crystal display device 1000 has the through hole 1083. Further, the recess 1058 corresponds to a circular hole and the wiring 1060 having a circular cross section can extend through the hole. The shape of the liquid crystal display device 1000 seen from the front surface may be other regular polygonal shape instead of the regular twelve-sided polygonal shape. The through hole 1083 may be multiple through holes 1083. Multiple recesses 1058 may be provided and multiple wirings 1060 may be provided.

### Eleventh Embodiment

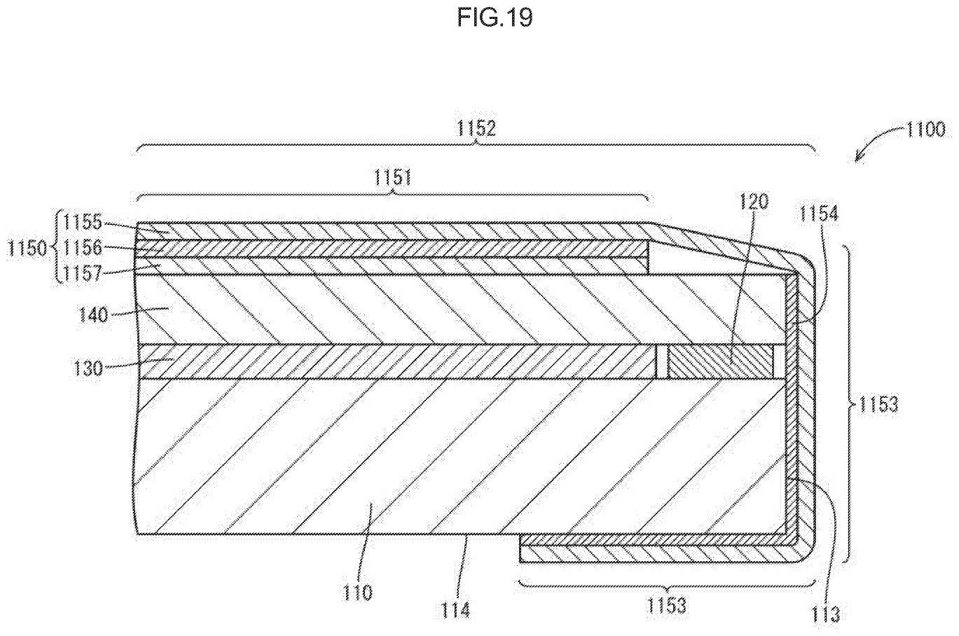

FIG. 19 illustrates a liquid crystal display device 1100 according to an eleventh embodiment of the present technology. Components same as those of the first embodiment are provided with the same symbols and the components and configuration same as those of the first embodiment will not be described. An optical film 1150 includes a front surface section 1152 that is attached to a front surface of the liquid crystal panel 140 and an extended section 1153 that extends from the front surface section 1152. The front surface section 1152 includes a polarizing section 1151 in a middle part thereof. The optical film 1150 of the present embodiment includes a first protection layer 1155 on the front surface side as a base member and further includes a polarizing layer 1156 and a second protection layer 1157 that are stacked on the back surface side in the polarizing section 1151. An adhesive layer 1154 is disposed on a part of the extended section 1153 and the extended section 1153 is fixed to a side surface of the liquid crystal panel 140 and the side surface 113 and the back surface 114 of the backlight 110.

According to the present embodiment, the optical film 1150, which includes the front surface section 1152 disposed on the front surface of the liquid crystal panel 140, is folded to be attached to the side surface 113 of the backlight 110. Accordingly, the liquid crystal panel 140 and the backlight 110 are fixed to each other with a simple and lightweight structure. Further, the optical film 1150 is folded and extended and attached to the back surface 114 of the backlight 110. The liquid crystal panel 140 and the backlight 110 are fixed to each other more firmly.

An adhesive layer may be provided on the back surface of the second protection layer such that the second protection layer may be bonded to the front surface of the liquid crystal panel 140. In such a configuration, the liquid crystal panel 140 and the backlight 110 are fixed to each other more firmly. An adhesive layer may be provided in an area that is included in the front surface section 1152 but not in the polarizing section 1151. In such a configuration, the liquid crystal panel 140 and the backlight 110 are fixed to each other more firmly. The second protection layer 1157 may not be provided and this may lead to reduction in thickness, weight, and a cost of the liquid crystal display device 1100 and increase in brightness thereof. In the configuration without having the second protection layer 1157, an adhesive layer may be provided on the back surface of the polarizing layer 1156 and in such a configuration, the liquid crystal panel 140 and the backlight 110 are fixed to each other more firmly. A light blocking layer may be provided in an area not including the polarizing layer 1156 and in such a configuration, stray light is less likely to leak outside.

1. A liquid crystal display device comprising:
a liquid crystal panel including two transparent substrates and a liquid crystal layer enclosing liquid crystals between the two transparent substrates, the liquid crystal panel having an alignment control region in which alignment of the liquid crystals is controlled;
a polarizing plate disposed opposite a back surface of the liquid crystal panel;
a backlight disposed opposite a surface of the polarizing plate that is not opposite the liquid crystal panel and supplying light to the polarizing plate; and
an optical film including a front surface section and an extended section, the front surface section being disposed on a front surface of the liquid crystal panel, and the extended section extending from one edge of the front surface section and attached to at least a part of a side surface of the backlight or at least a part of a back surface of the backlight, wherein
the front surface section includes in a part thereof a polarizing section that polarizes transmission light and the polarizing section overlaps the alignment control region.

2. The liquid crystal display device according to claim 1, wherein the extended section is attached to the at least the part of the back surface of the backlight and the at least the part of the side surface of the backlight.

3. The liquid crystal display device according to claim 1, wherein the optical film includes:
a first protection layer;
an adhesive layer or a pressure sensitive adhesive layer disposed on a back surface of the first protection layer; and
a polarizing layer disposed on a front surface of the first protection layer in the polarizing section and configured to polarize transmission light.

4. The liquid crystal display device according to claim 3, further comprising a second protection layer disposed on a front surface of the polarizing layer, the second protection layer configured to protect the polarizing layer.

5. The liquid crystal display device according to claim 4, wherein the second protection layer is a layer of one of triacetylcellulose, polyethylene terephthalate, polypropylene, and acrylic resin or a layer of mixture or stacking layers of two or more of triacetylcellulose, polyethylene terephthalate, polypropylene, and acrylic resin.

6. The liquid crystal display device according to claim 1, wherein the optical film includes:
a first protection layer;
a polarizing layer disposed on a back surface of the first protection layer in the polarizing section and configured to polarize transmission light; and
an adhesive layer or a pressure sensitive adhesive layer disposed on a part of a back surface of the first protection layer, the part not including the polarizing layer.

7. The liquid crystal display device according to claim 3, wherein the first protection layer is a layer of one of triacetylcellulose, polyethylene terephthalate, polypropylene, and acrylic resin or a layer of mixture or stacking layers of two or more of triacetylcellulose, polyethylene terephthalate, polypropylene, and acrylic resin.

8. The liquid crystal display device according to claim 3, wherein the polarizing layer is made of polyvinyl alcohol as a main material.

9. The liquid crystal display device according to claim 3, wherein the extended section has no polarizing layer.

10. The liquid crystal display device according to claim 1, wherein the optical film includes a light blocking layer in a portion thereof.

11. The liquid crystal display device according to claim 3, further comprising a light blocking layer in a part of a front surface of the first protection layer where the polarizing layer is not provided.

12. The liquid crystal display device according to claim 10, wherein the light blocking layer is one of a light absorbing layer and a light reflecting layer or a multilayer of the light reflecting layer and the light absorbing layer.

13. The liquid crystal display device according to claim 1, wherein a part of a back surface of the liquid crystal panel is fixed to a part of a front surface of the backlight with an adhesive tape.

14. The liquid crystal display device according to claim 1, wherein.
the liquid crystal panel is connected to wiring through which electric signals for controlling alignment of the liquid crystal panel are transferred to the liquid crystal panel, and
the extended section has a recess through which the wiring extends outside.

15. The liquid crystal display device according to claim 1, wherein the front surface section has a quadrangular shape or a polygonal shape and the extended section extends from at least two sides of the front surface section.

16. The liquid crystal display device according to claim 1, wherein the extended section has a corner that is cut off.

17. The liquid crystal display device according to claim 1, wherein the polarizing section includes one of an opening, a recess, and a round corner.

18. The liquid crystal display device according to claim 17, wherein the polarizing plate has one of the opening, the recess, and the round corner having a substantially same shape as the one included in the polarizing section seen from a front surface side.

19. The liquid crystal display device according to claim 1, wherein the front surface section includes one of an opening, a recess, chamfering, and a round corner.

20. The liquid crystal display device according to claim 19, wherein the liquid crystal panel and the backlight have one of the opening, the recess, the chamfering, and the round corner having a substantially same shape as the one included in the front surface section seen from a front surface side.
